(19) United States
(12) Patent Application Publication
(10) Pub. No.: US 2002/0167881 A1
(43) Pub. Date: Nov. 14, 2002

(54) Disk ejecting mechanism for an optical disk drive

(76) Inventor: Ta-Hsiang Wang, Taipei (TW)

Correspondence Address: OPPENHEIMER WOLFF & DONNELLY, P. O. BOX 10356, PALO ALTO, CA, 94303, US

(21) Appl. No.: 09/931,070

(22) Filed: Aug. 15, 2001

(30) Foreign Application Priority Data
May 9, 2001 (TW) 90207560

(51) Int. Cl. G11B 33/02

(52) U.S. Cl. 369/77.1; 369/75.1

(57) ABSTRACT

A disk ejecting mechanism for an optical disk drive is provided. The optical disk drive is provided with a holder for holding a disk. The disk ejecting mechanism comprises a cross rod and a switch. The cross rod, connected to the holder, has a guide slot formed thereon. The switch is provided with a pull rod located within the guide slot. The pull rod, moving along the guide slot in a first direction, drives the cross rod to move in a second direction perpendicular to the first direction. Hence, after the pull rod is moved, it drives the cross rod to drive the holder so that the disk is ejected.

### BACKGROUND OF THE INVENTION

1. Field of the Invention

The invention relates to a disk ejecting mechanism for an optical disk drive; in particular, the invention relates to an optical disk drive that can readily eject a disk under special conditions.

2. Description of the Related Art

An optical disk drive is a data storage system that is used to read data on an optical disk, and is an important data storage system. Optical disks are cheap, their capacity is extremely large, and they can store various file formats, including music, images, programs, and data. Therefore, if the computer is not provided with an optical disk drive, users cannot enjoy certain functions.

Disk loading and disk ejecting are basic functions of an optical disk drive. Generally, the power of an optical disk drive is transmitted by a motor through a gear set. Thus, the ejecting mechanism of the optical disk drive is driven so that a tray (not shown) of the optical disk drive is ejected.

As shown in FIG. 1, the conventional ejecting mechanism of the optical disk drive is provided with a cross rod 10a. A gear set 50a drives the cross rod 10a to move in a lateral direction so that a flute (not shown) of the cross rod 10a drives a disk holder 20a to move in an upward and downward direction. Thus, disk loading and disk ejecting are attained.

The cross rod 10a of the conventional optical disk drive is provided with a guide slot 11a. The guide slot 11a is linear, as shown in FIG. 2a, FIG. 2b, FIG. 3a and FIG. 3b. When the gear set 50a drives the cross bar 10a to move in a lateral direction, the cross rod 10a does not only drive the disk holder 20a to move in an upward and downward direction via the flute (not shown), it also drives a pull rod 30a to move in a lateral direction via the guide slot 11a. As a result, a motor 60a is turned on or off.

However, in the conventional ejecting mechanism of the optical disk drive, the guide slot 11a of the cross rod 10a is linear. When the disk inside the optical disk drive is ejected in an emergency condition, the user must manually push an emergent member 40a to rotate about 90 degrees so as to indirectly apply force to the cross rod 10a to eject the disk. The operation of the emergent member 40a is very inconvenient. Furthermore, due to the addition of the emergent member 40a, the whole structure of the optical disk drive is more complicated, and its assembly is more difficult. Moreover, the cost is higher.

### SUMMARY OF THE INVENTION

In order to address the disadvantages of the aforementioned optical disk drive, the present invention provides an optical disk drive that can readily eject a disk under special conditions.

Another purpose of this invention is to simplify the whole structure and the assembly of the optical disk drive.

Accordingly, the invention provides a disk ejecting mechanism for an optical disk drive. The optical disk drive is provided with a holder for holding a disk. The disk ejecting mechanism comprises a cross rod and a switch. The cross rod, connected to the holder, has a guide slot formed thereon. The switch is provided with a pull rod located within the guide slot. The pull rod, moving along the guide slot in a first direction, drives the cross rod to move in a second direction perpendicular to the first direction. Hence, after the pull rod is moved, it drives the cross rod to drive the holder so that the disk is ejected.

Furthermore, the guide slot is formed such that it crosses the first direction and the second direction.

Furthermore, the guide slot is curved in shape.

Furthermore, the cross rod is located above the switch.

### BRIEF DESCRIPTION OF THE DRAWINGS

The invention is hereinafter described in detail with reference to the accompanying drawings in which:

FIG. 1 is a schematic view depicting a conventional ejecting mechanism of an optical disk drive;

FIG. 2a is a top view depicting the conventional ejecting mechanism in a condition in which a disk is loaded;

FIG. 2b is a schematic view depicting the conventional ejecting mechanism in a condition in which the disk is loaded;

FIG. 3a is a top view depicting the conventional ejecting mechanism in a condition in which the disk is ejected;

FIG. 3b is a schematic view depicting the conventional ejecting mechanism in a condition in which the disk is ejected;

FIG. 4 is a schematic view depicting an ejecting mechanism of an optical disk drive of the present invention;

FIG. 5a is a top view depicting the ejecting mechanism of this invention in a condition in which a disk is loaded;

FIG. 5b is a schematic view depicting the ejecting mechanism of this invention in a condition in which the disk is loaded;

FIG. 6a is a top view depicting the ejecting mechanism of this invention in a condition in which the disk is ejected; and

FIG. 6b is a schematic view depicting the ejecting mechanism of this invention in a condition in which the disk is ejected.

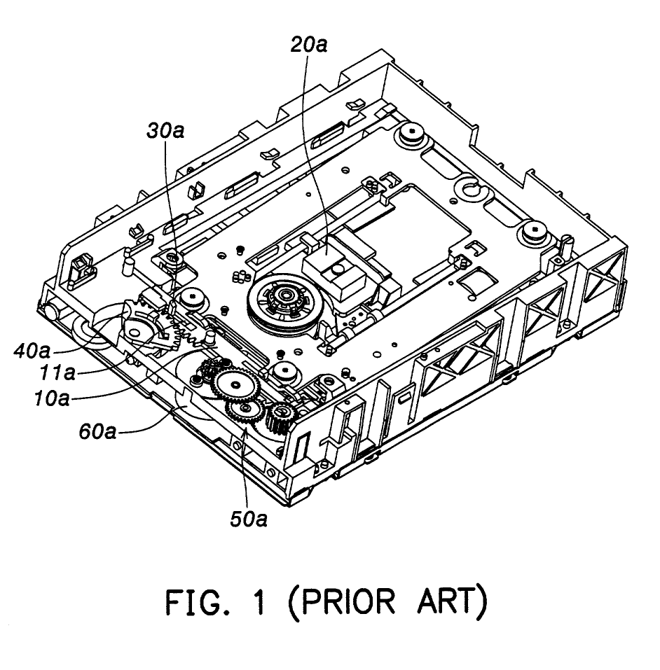

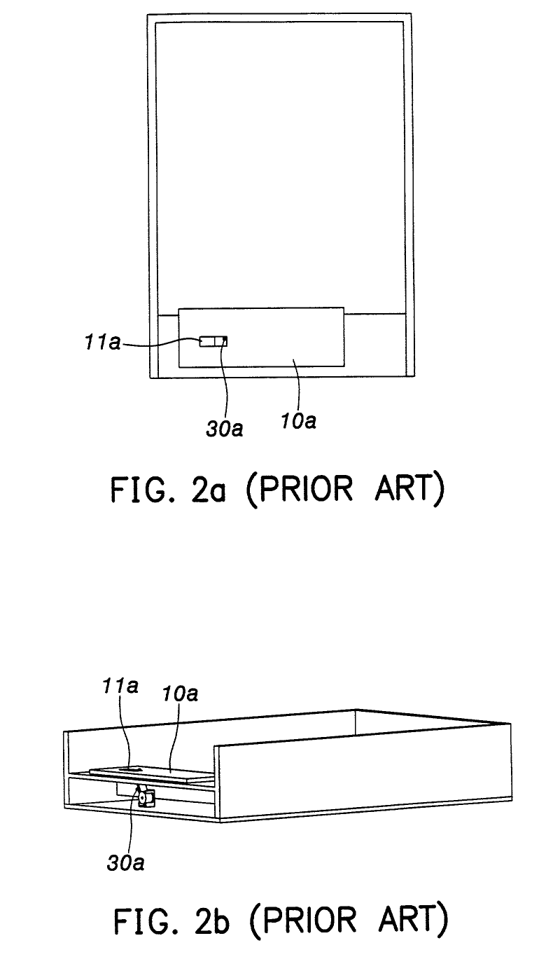

### DETAILED DESCRIPTION OF THE INVENTION

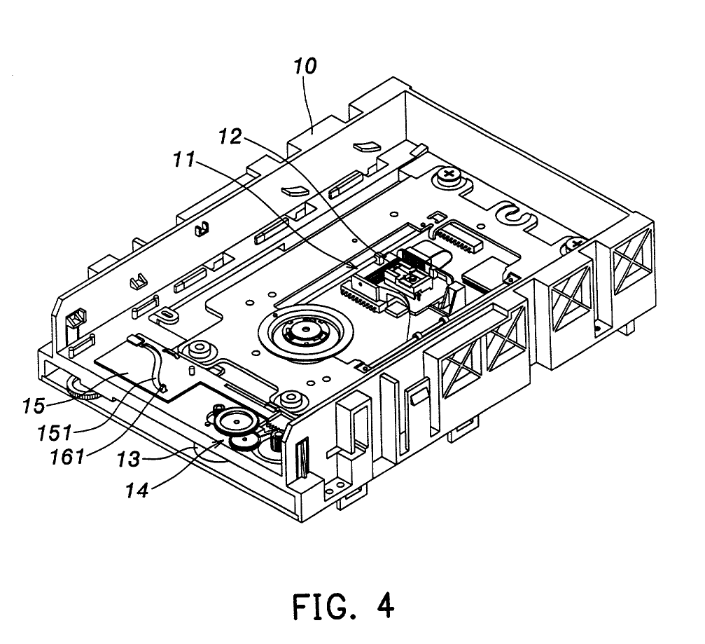

Referring to FIG. 4, a disk ejecting mechanism for an optical disk drive of the present invention is provided. Generally, a holder 11 is disposed on a body 10 of the optical disk drive. A reading optical head 12 is disposed on the holder 11 so as to read the data of an optical disk. The power of the optical disk drive is transmitted by a motor 13 through a gear set 14. Thus, the ejecting mechanism of the optical disk drive is driven so that a tray (not shown) of the optical disk drive is ejected.

The ejecting mechanism of the optical disk drive is provided with a cross rod 15 that is disposed on the body 10 and connected to the holder 11. The cross rod 15 also connects to the motor 13 through the gear set 14. The motor 13 drives the gear set 14 to drive the cross rod 15 to move in a lateral direction so that a flute (not shown) of the cross rod 15 drives the holder 11 to move in an upward and downward direction. Thus, disk loading and disk ejecting are attained.

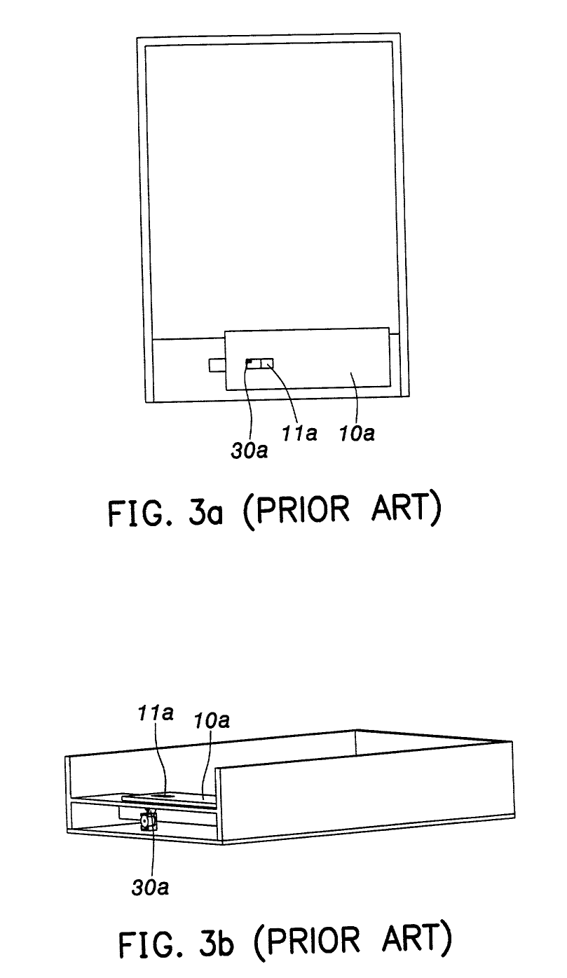

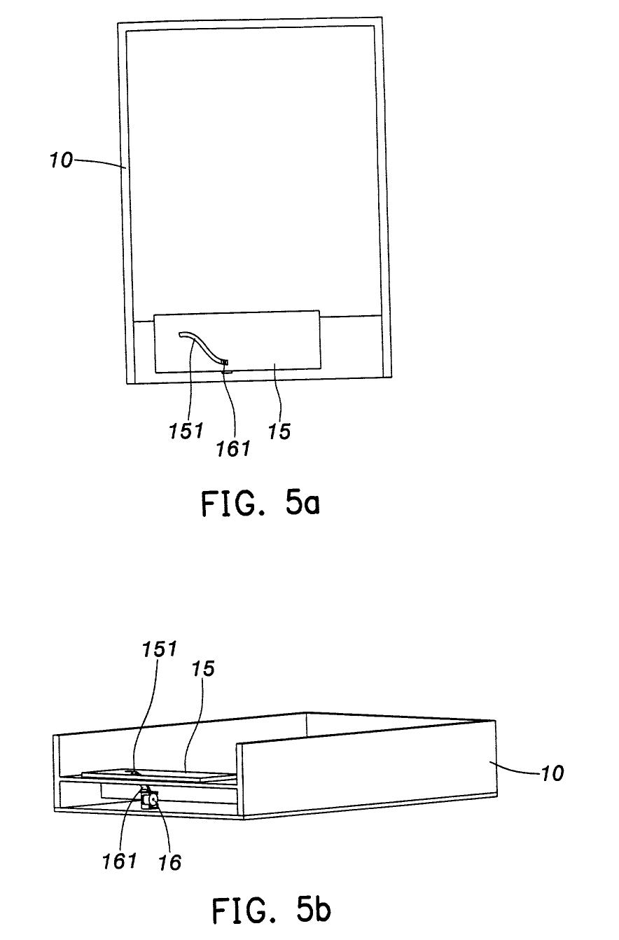

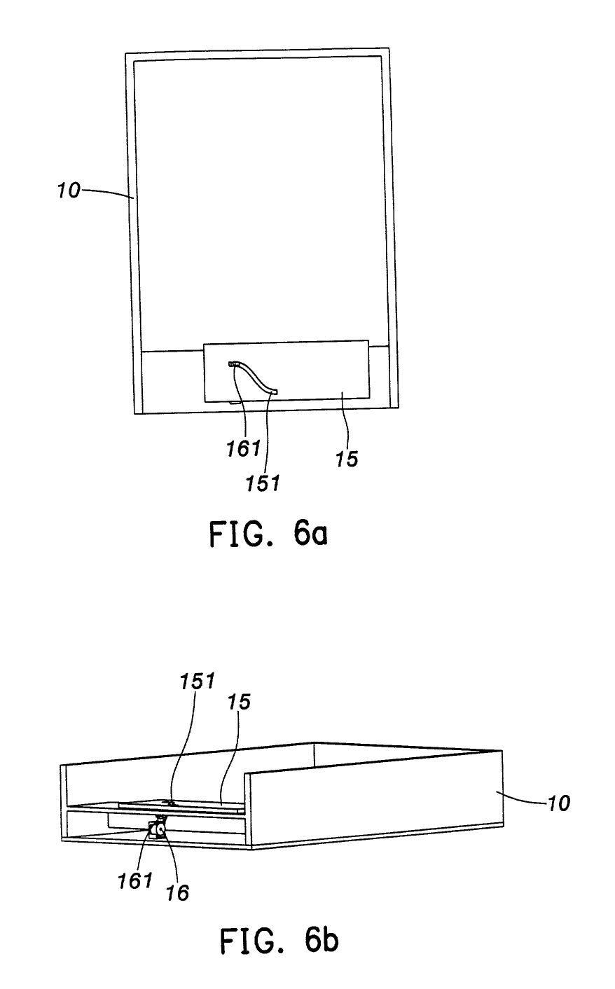

The cross rod 15 is provided with a guide slot 151. The guide slot 151 is curved in shape. In addition, if the cross rod 15 is a rectangular shape, the guide slot 151 may be a linear shape diagonal to comers of the cross rod 15. A switch 16 is located beneath the cross rod 15, as shown in FIG. 5a, FIG. 5b, FIG. 6a and FIG. 6b. There is a 90-degree difference between the orientation of the switch 16 and the conventional switch. Specifically, the pull rod 30a of the conventional switch, as shown in FIG. 3a, moves in a lateral direction, but the pull rod 161 of the switch 16 moves in a longitudinal direction (hereinafter referred as a first direction) perpendicular to the lateral direction (hereinafter referred as a second direction). The pull rod 161 is located within the guide slot 151, and it can move along the guide slot 151 that is formed in a manner that it crosses the first direction and the second direction. In other words, the ejecting mechanism of this invention further comprises the cross rod 15, with the curved guide slot 151, and the pull rod 161 moving in the first direction.

When the gear set 14 drives the cross bar 15 to move in the second direction, the cross rod 15 does not only drive a holder 11 to move in the upward and downward direction via the flute (not shown), it also drives the pull rod 161 to move in the first direction via the guide slot 151. As a result, the motor 13 is turned on or off.

Accordingly, when the disk inside the optical disk drive of this invention needs to be ejected in an emergency condition, the user can directly push the pull rod 161 to achieve the disk-ejection. Comparatively, when the disk inside the conventional optical disk drive needs to be ejected in an emergency condition, the user must manually push the emergent member to rotate about 90 degrees so as to indirectly apply force to the cross rod to eject the disk. Hence, the operation of this invention is more convenient. Furthermore, the whole structure of the optical disk drive is more simplified, and its assembly is easier. Moreover, the cost is down.

While the invention has been particularly shown and described with reference to a preferred embodiment, it will be readily appreciated by those of ordinary skill in the art that various changes and modifications may be made without departing from the spirit and scope of the invention. It is intended that the claims be interpreted to cover the disclosed embodiment, those alternatives which have been discussed above, and all equivalents thereto.

What is claimed is

1. A disk ejecting mechanism for an optical disk drive, wherein the optical disk drive is provided with a holder for holding a disk, and the disk ejecting mechanism comprises:
a cross rod, connected to the holder, having a guide slot formed thereon; and
a switch provided with a pull rod located within the guide slot, wherein the pull rod, moving along the guide slot in a first direction, drives the cross rod to move in a second direction perpendicular to the first direction, whereby after the pull rod is moved, it drives the cross rod to drive the holder so that the disk is ejected.

2. The disk ejecting mechanism as claimed in claim 1, wherein the guide slot is formed in a manner that it crosses the first direction and the second direction.

3. The chamber as claimed in claim 2, wherein the guide slot is curved in shape.

4. The chamber as claimed in claim 1, wherein the cross rod is rectangular in shape, and the guide slot is linear in shape diagonal to comers of the cross rod.

5. The chamber as claimed in claim 3, wherein the cross rod is located above the switch.

6. The chamber as claimed in claim 4, wherein the cross rod is located above the switch.
